(19) United States
(12) Patent Application Publication
(10) Pub. No.: US 2008/0184494 A1
(43) Pub. Date: Aug. 7, 2008

(54) Staple holder

(76) Inventor: Benjamin V. Govotski, Harwinton, CT (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/012,780

(22) Filed: Feb. 5, 2008

Related U.S. Application Data
(60) Provisional application No. 60/899,688, filed on Feb. 6, 2007.

(51) Int. Cl. B25C 3/00; B65D 69/00; B65D 85/24; B25F 1/00; B65H 1/12

(52) U.S. Cl. 7/164; 81/44; 206/341; 221/199

(57) ABSTRACT

A staple holder for driving staples into a suitable surface, such as driving U-shaped staples during installation of wire, such as barbed wire, or wire cloth, such as chicken wire, includes a headpiece that defines an opening and a handle that extends essentially normal to a major axis of the opening. The headpiece can include magnets to facilitate holding a staple in the headpiece. The handle can include markings, such as would be employed to properly distance staples during use of the staple holder.

### RELATED APPLICATION(S)

This application claims the benefit of U.S. Provisional Application No. 60/899,688, filed on Feb. 6, 2007.

The entire teachings of the above application are incorporated herein by reference.

### BACKGROUND OF THE INVENTION

U-shaped staples commonly are employed to attach wire, such as barbed wire, and fencing materials, such as chicken mesh, to wooden fence posts or some other backing. Typically, the staples are held in place by hand and then hammered into the backing to secure the wire or fencing material. Often, wire or fencing material must be held in tension while the staple is being hammered into the backing. The force employed to hold the wire or cloth in place often can cause the staple to be difficult to stabilize. Further, such fencing materials are often installed outdoors in a wide variety of terrain. If the fence is to contain animals, it is important not to drop staples into the grass or onto the ground so that they will not accidentally be ingested and to prevent them from otherwise injuring the animals. Further, small staples, such as U-shaped staples having a length of three-quarters of an inch, which are typically employed to secure chicken mesh, can be very difficult to hold by hand during installation.

Therefore, there is a need for an apparatus to hold staples, such as U-shaped staples, during installation of wire fencing materials that overcomes or minimizes the above-referenced problems.

### SUMMARY OF THE INVENTION

The invention generally is directed to a staple holder for use in holding U-shaped staples during installation of fencing materials, such as barbed wire, chicken mesh and other wire cloths to supports, such as wooden fence posts.

In one embodiment, the staple holder includes a headpiece defining an elongate opening on one side. A handle extends from a second side of the headpiece, the handle having a major axis that is essentially normal to a major axis of the opening defined by the headpiece. The headpiece can include a magnetic component that, depending upon the embodiment, defines, at least in part, the opening of the headpiece. Alternatively, the magnetic component is embedded in the headpiece and does not define any part of the opening in the headpiece. The headpiece can define a surface that is essentially normal to a major access of the opening, the surface defining a plane that intersects the major axis of the opening and is opposite to the opening. In one embodiment, the surface includes a layer of material that is harder than a substantial portion of the remainder of the headpiece.

In one embodiment, the headpiece of the staple holder defines a magazine that is in fluid communication with the opening, whereby a cartridge of staples can be loaded into the magazine. In a specific embodiment, the magazine is spring-loaded, whereby staples are automatically fed from a cartridge into the opening.

The headpiece and the handle can, depending upon the embodiment, independently be formed of a material that includes at least one of iron, wood and plastic. In one embodiment, the headpiece and handle are of the same material.

In another specific embodiment, the handle includes markings that indicate measurements in English or metric units. In a specific embodiment, the handle includes a retractable component that indicates measurements in English or metric units.

This invention has many advantages. For example, U-shaped staples can be held in place mechanically, rather than manually, during installation of wire fencing. Mechanical placement of staples during installation means that the staples can be hammered at least partially into place by impacting the tool holding the staple, thereby avoiding injury by movement of the staple or misplaced impaction by a hammer or other tool. Further, the staple holder of the invention, can hold a staple in place with greater stability, thereby permitting greater efficiency during installation of wire fencing material, particularly when a wire fence must be held under tension during installation. In addition, staples held in the staple holder of the invention are less likely to drop than is the case when holding staples are held in place manually, thereby further increasing efficiency of fencing installation and significantly reducing the likelihood that staples will be left behind that might cause injury to livestock.

Further, the handle of the staple holder can be employed as a means for measuring the appropriate distance between staples or fence posts, thereby providing multiple functions in a single tool. Markings along the handle also can be employed to improve efficiency of installation by, for example, correctly distancing staples from each other. In the embodiment where the headpiece of the tool defines a magazine, the plurality of staples can be loaded in the headpiece by, for example, use of a cartridge. The staples can then automatically be fed through the headpiece by, for example, spring loading the magazine, thereby further improving the efficiency of wire fence installation.

### BRIEF DESCRIPTION OF THE DRAWINGS

FIG. 1 is a perspective view of one embodiment of the staple holder of the invention.

FIG. 2 is a perspective view of the headpiece of the embodiment of the staple holder represented in FIG. 1, illustrating the shape of an opening defined by the headpiece.

FIG. 3 is a cross-section of the headpiece from the staple holder as shown in FIGS. 1 and 2, and further including a U-shaped staple within the opening defined by the headpiece.

FIG. 4. is a cross-section of another embodiment of the staple holder of the invention, including a hammer-like side of the headpiece and a magnetic component within the opening defined by the headpiece.

FIG. 5 is still another embodiment of the staple holder of the invention, including a spring-loaded magazine defined by the headpiece and a cartridge of staples within the magazine.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention. The teachings of all patents, published applications and references cited herein are incorporated by reference in their entirety.

The invention generally is directed to a staple holder for stabilizing U-shaped staples during installation of fencing material, such as barbed wire, chicken mesh or wire cloth of any type designed to contain animals.

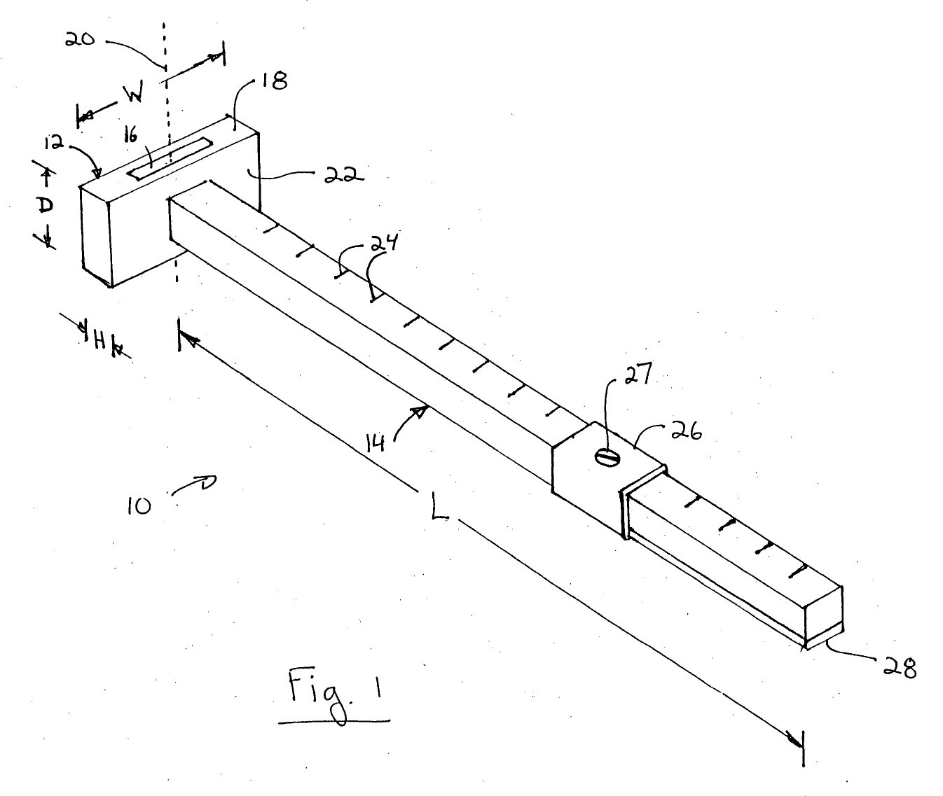

In one embodiment of the invention, shown in FIG. 1, staple holder 10 includes headpiece 12 and handle 14. Headpiece 12 defines an elongate opening 16 on side 18. Elongate opening 16 has major axis 20. Handle 14 extends from side 22 of headpiece 12. Handle 14 has a major axis that is essentially normal to major axis 20 of opening 16 defined by headpiece 12. Handle 14 includes markings 24 along its length that indicate units of length. Units of length can be, for example, English or metric units. Raised portion 26 of handle can, optionally, represent a component of the units of measure marked along the length of handle 14. In still another embodiment raised portion 26 can be moved along handle, and fixed at any point along handle by use of set screw 27. Optionally, handle 14 also includes retractable component 28 that also may be employed as a measuring device. Also optionally, retractable component 28 is removable from handle 14.

Generally, headpiece 12 has width W in a range of between about 2 inches and about 2¼ inches. In a preferred embodiment, width is about two inches. Height H of headpiece 12 generally is in a range of between about 0.5 inches and about 0.625 inches. A preferred height is about one-half inch. Depth D of headpiece 12 generally is in a range of between about 1 inch and about 1 and 1/16 inches. In a preferred embodiment, the depth is about one inch. Also, in a preferred embodiment, raised portion 26 of handle 14 is about two inches in length and is centered at a distance of about eleven inches from the center line of opening 16 at headpiece 12. In addition, handle 14 generally has a length L and a range of between about 12 inches and about 18 inches. Preferably, the length of handle 14 is about eighteen inches. Typically, handle 14 has a square cross-section. The width and height of handle 14 typically is about ½ inches by about ½ inches. Preferably, the height and width of handle 14 is about one-half inch.

Headpiece 12 and handle 14 can be formed of any suitable impact resistant material. Examples of suitable impact resistant materials include metal, such as iron, and hardened steel. Headpiece 12 and handle 14 can be of the same or different materials. In a particularly preferred embodiment, headpiece 12 and handle 14 are fabricated separately of steel, such as hardened steel, or iron, and then welded together.

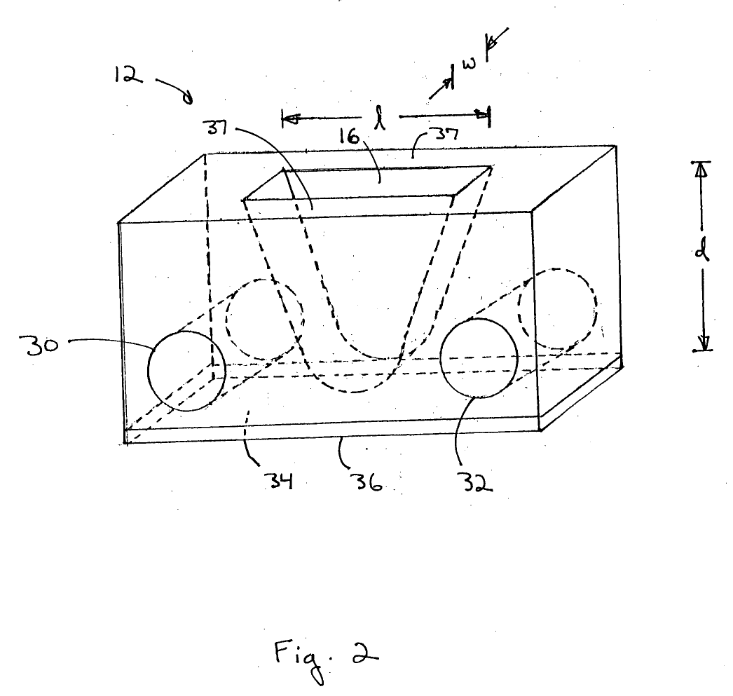

FIG. 2 is a perspective view of one embodiment of headpiece 12. Opening 16 defined by headpiece, is shown, in part, in outline. Magnets 30, 32, which are optional, are embedded in headpiece 12 on either side of opening 16. It is to be noted that magnets can be, in addition, or alternatively, located in other positions in headpiece 12, such as in either or both walls 37 of headpiece 12 parallel to length l of opening 16. Headpiece 12 defines a surface 34, shown in outline, that is essentially normal to major axis 20 of opening 16. Surface 34 defines a plane that intersects major axis 20 of opening 16 and is opposite to opening 16. Also, optionally, surface 34 includes layer 36 of material that is harder than a substantial portion of the remainder of headpiece 12. In one embodiment, the material of layer 36 is of hardened steel. Opening 16, defined by headpiece 12, has a length l in a range of between about ¾ inches and about 25/32 inches and width w in a range of between about 3/16 inches and about 7/32 inches. The depth d of opening defined by headpiece typically has a range of between about ¾ inches and about 25/32 inches. In a preferred embodiment, length l of opening is ¾ inches, width w is about 3/16 inches and depth d is about ¾ inches.

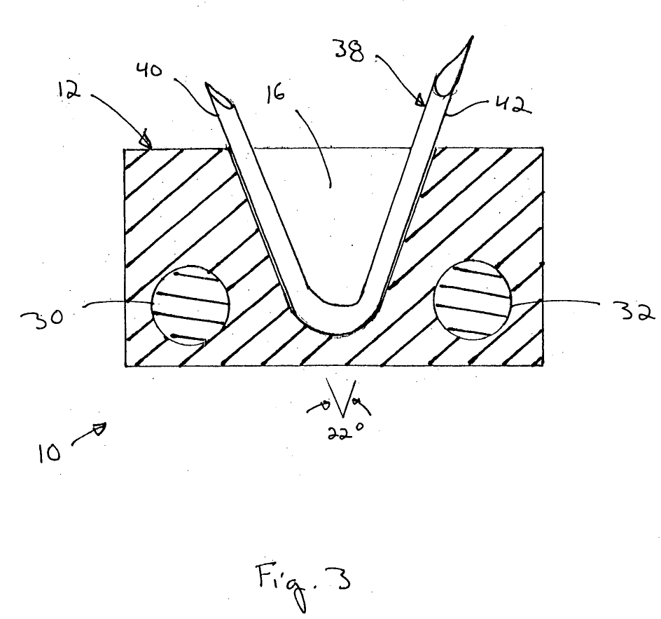

FIG. 3 is a cross section of headpiece 12 shown in FIG. 2 and includes U-shaped staple 38 resting in opening 16 defined by headpiece 12. In one embodiment, the angle of walls of opening 16 is about 22°, as shown. It is to be noted that prongs 40, 42 of U-shaped staple 38 extend from headpiece 12. Staple holder 10 is employed by placing U-shaped staple 38 into opening 16 and then holding surface 44 of headpiece approximate to a fence post, or other suitable receiving material while U-shaped staple 38 straddles a component of barbed or other type of wire, or a wire strand of chicken mesh or some other type of wire cloth. Headpiece 12 is then impacted while U-shaped staple 38 is being held in place by headpiece 12 to thereby cause the prongs 40, 42 of U-shaped staple 38 to penetrate the receiving material. In one embodiment, surface 44 is essentially normal to major axis 20 of opening, wherein surface 44 is at opening 16 defined by the headpiece 12 and intersects major axis 20 of opening 16. Headpiece 12 is impacted such as by use of a hammer or other blunt instrument, until surface 44 is about flush with the receiving material. Headpiece 12 is then removed from U-shaped staple 38, at which time U-shaped staple 38 is stable without support by headpiece 12 and can be driven further into the receiving material either by continued use of a hammer or other blunt instrument.

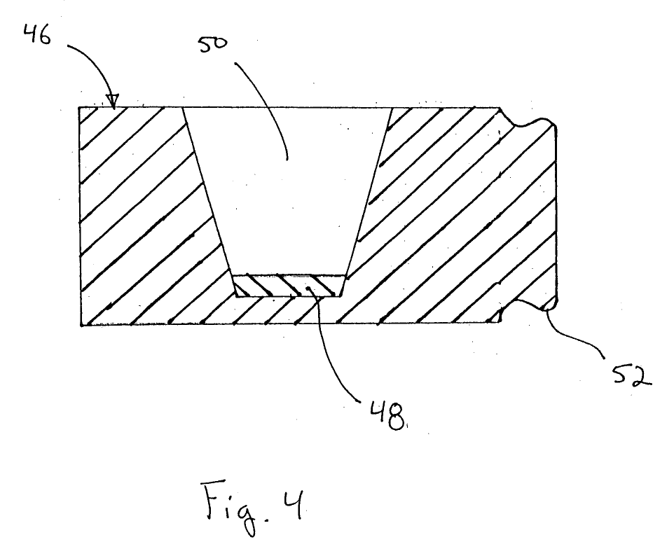

In another embodiment of the invention, headpiece 46, a cross-section of which is shown in FIG. 4, includes a magnet 48 within opening 50 defined by headpiece 46. Magnet 48 thereby defines, at least in part, opening 50 in which a U-shaped staple (not shown) is held. It is to be understood that headpiece 46 can include a variety of configurations, such as a hammer-like shape 52, at one end, such as is shown in FIG. 4, or on the side of headpiece 46 opposite to opening 50. Hammer-like shape 52 can be employed to impact a U-shaped staple, once it has been stabilized in a receiving surface following initial placement, as described above.

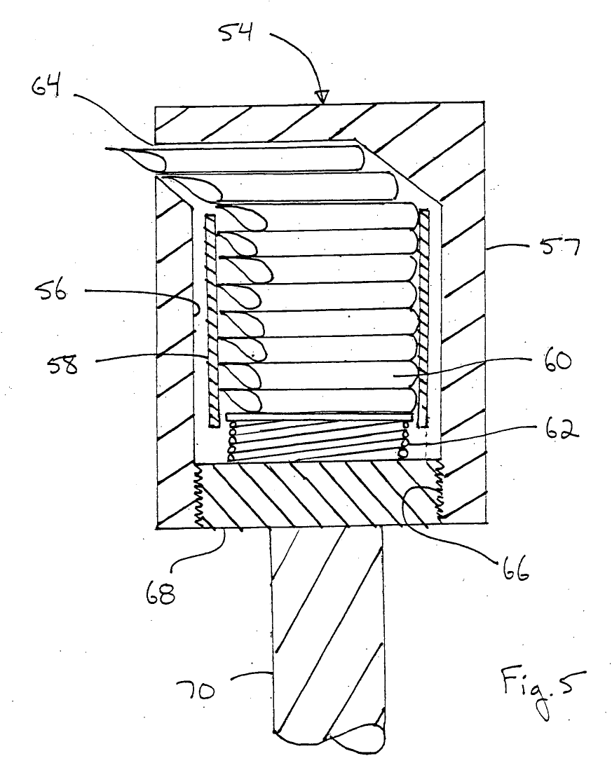

In still another embodiment of the invention, headpiece 54, a cross-section in which is shown in FIG. 5, defines magazine 56 and includes housing 57. Cartridge 58 of staples 60 is held within magazine 56. Spring 62 of magazine 56 biases staples 60 toward opening 64 defined by headpiece 54. Cartridge 58 can be loaded into housing through breech opening 66, which is sealed by threaded breech block 68. Threaded breech block is attached to handle 70.

Following initial stabilization by impacting headpiece 54 against a receiving surface and subsequent withdrawal of headpiece 54 from a stabilized staple, a subsequent staple 60 will be directed by spring 62 from cartridge 58 into opening 64 for placement at the next location during installation of, for example, barbed wire or fencing material. Staples are thereby automatically fed through opening 64 to improve efficiency of installation operations.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A staple holder, comprising:
a) a headpiece defining an elongate opening on one side; and
b) a handle extending from a second side of the headpiece, the handle having a major axis essentially normal to a major axis of the opening defined by the headpiece.

2. The staple holder of claim 1, wherein the headpiece includes a magnetic component that holds a staple within the elongate opening.

3. The staple holder of claim 2, wherein the magnetic component defines, at least in part, the opening in the headpiece.

4. The staple holder of claim 2, wherein the magnetic component includes at least two magnets embedded in the headpiece, and which do not define the opening of the headpiece.

5. The staple holder of claim 1, wherein the headpiece defines a surface essentially normal to a major axis of the opening, the surface defining a plane that intersects the major axis of the opening and is opposite to the opening.

6. The staple holder of claim 5, wherein the surface includes a layer of material that is harder than a substantial portion of the remainder of the headpiece.

7. The staple holder of claim 1, wherein the headpiece defines a surface essentially normal to a major axis of the opening, the surface defining a plane that intersects the major axis of the opening and is at the opening defined by the headpiece.

8. The staple holder of claim 1, wherein the headpiece includes at least one of iron, wood and plastic.

9. The staple holder of claim 1, wherein the opening defined by the headpiece has a width in a range of between about 2 inches and about 2¼ inches, a height in a range of between about ½ inches to about 1/16 inches, and a depth in a range of between about 1 inch and about 1 and 1/16 inches.

10. The staple holder of claim 9, wherein the headpiece has a width in a range of between about 3 inches and about 3½ inches, a height in a range of between about 4 inches and about 4¼ inches, and a depth in a range of between about 2 inches and 2½ inches.

11. The staple holder of claim 10, wherein the headpiece has a weight in a range of between about 1 lb and about 1¼ lbs.

12. The staple holder of claim 1, wherein the headpiece includes a magazine in communication with the opening, whereby a cartridge of staples can be loaded into the magazine.

13. The staple holder of claim 1, wherein the magazine is spring-loaded, whereby staples are automatically fed from a cartridge into the opening.

14. The staple holder of claim 1, wherein the handle has a length of at least about 18 inches.

15. The staple holder of claim 14, wherein the handle is of the same material as the headpiece.

16. The staple holder of claim 15, wherein the handle includes at least one of iron, wood and plastic.

17. The staple holder of claim 1, wherein the handle includes markings that indicate measurement in English or metric units.

18. The staple holder of claim 1, wherein the handle has an essentially square cross-section at least one point along its length.

19. The staple holder of claim 1, wherein the handle includes a recessed portion along its length.

20. The staple holder of claim 1, wherein the handle includes a retractable component.

21. The staple holder of claim 20, wherein the retractable component is a ruler that indicates measurements in English or metric units.
